(19) United States
(12) Patent Application Publication
(10) Pub. No.: US 2023/0241641 A1
(43) Pub. Date: Aug. 3, 2023

(54) CLEANING CAVITY SERIES FOR EXTRUSION TYPE COATING AND CLEANING METHOD FOR EXTRUSION TYPE COATING

(71) Applicant: JIANGSU KATOP AUTOMATION CO., LTD., Jiangsu (CN)

(72) Inventor: Zhenhua FAN, Jiangsu (CN)

(21) Appl. No.: 18/011,110

(22) PCT Filed: Dec. 2, 2020
(86) PCT No.: PCT/CN2020/133454

§ 371 Date: Dec. 16, 2022

(30) Foreign Application Priority Data
Jun. 18, 2020 (CN) 202010559513.1

(51) Int. Cl. B05C 11/00; B08B 3/04; B08B 5/02; B05C 5/02

(52) U.S. Cl. CPC B05C 11/00; B08B 3/04; B08B 5/02; B05C 5/0254

(57) ABSTRACT

Provided are a cleaning cavity series for extrusion type coating, and a cleaning method. The cleaning cavity series for extrusion type coating includes a plurality of cleaning cavities, where the plurality of cleaning cavities form the cleaning cavity series, each of the plurality of cleaning cavities is provided with an inner cavity body, a cleaning cavity opening portion in communication with the inner cavity body is disposed on a side portion of each of the plurality of cleaning cavities, and cross-section outlines of the inner cavity bodies of the plurality of cleaning cavities are a series of curves with an equal chord length. The cleaning method includes: S1: evaluating an envelope line of a slurry that overflows from a lip portion of a coating head, and selecting one cleaning cavity from a cleaning cavity series to ensure that an enveloped area of the envelope line accounts for 30%-70% of the sectional area of an inner cavity body of the selected cleaning cavity; and S2: selecting a static cleaning method or a dynamic cleaning method to perform a cleaning operation on the coating head using the selected cleaning cavity from the cleaning cavity series. The cleaning cavity series for extrusion type coating, and the cleaning method using same have the advantages of having a simple structure, being convenient to apply, being low in implementation cost, and improving the cleaning effect, the coating quality and the production efficiency.

### TECHNICAL FIELD

The present disclosure relates to the field of lithium battery production and, in particular, to a cleaning cavity series for extrusion type coating and a cleaning method for extrusion type coating.

### BACKGROUND

With the development and maturity of new energy technology, the application of lithium batteries becomes increasingly wide, and the market prospect of lithium batteries is getting better and better.

In the production process of lithium batteries, the coating of the lithium battery is a very important process. The coating of the lithium battery is usually achieved by means of a coating head. After the coating head completes the coating of the lithium battery, the slurry overflowing from the coating head needs to be cleaned timely. Otherwise, the slurry will solidify over time, contaminate the next coating and equipment, and clog within the coating head, affecting the normal coating operation. Therefore, an enterprise needs to clean the coating head in a manual cleaning method, which consumes a large amount of labor, causes high labor intensity and a poor working environment, and even takes a lot of time on cleaning, thereby seriously affecting the coating efficiency and coating quality and reducing the production efficiency of the production enterprise.

At this point, the present enterprise provides a new technical solution: an on-line automatic cleaning apparatus of slit extrusion type coating die for lithium battery and cleaning method thereof, which are disclosed in patent application number: CN201910470439.3. Such a technical solution achieves the sealing of a cleaning cavity and a coating head and has a good effect on the slurry with a certain viscosity after a lip portion of the coating head is cleaned using a cleaning agent and restored for coating; the lip portion of the coating head has no dried slurry and the coating is free of missing coating. The technical means provided by the preceding technical solution can effectively solve the technical problems of the manual cleaning of the coating head and bring the advantages of high efficiency, environmental protection and labor cost saving.

However, in the preceding technical solution, when the cleaning cavity deals with various slurries, because of the large difference in slurry viscosities, the cleaning cavity cannot match the coating work when the slurry has different viscosities or when various slurries of different viscosities are mixed, and the cavity is easily filled with the slurry at one time or the slurry “overflows, fills and solidifies” in the cavity due to a long downtime. When the cleaning function is enabled, the cleaning cavity may not be penetrated because the slurry is filled or even solidified in the cleaning cavity, and the cleaning operation may fail.

In view of this, the object of the present disclosure is to provide a new technical solution to solve the existing technical defects.

### SUMMARY

In order to broaden the application range of the coating head cleaning cavity and deal with slurries of different viscosities and even the mixing of various slurries, it is necessary to optimize the cleaning cavity series, evaluate the viscosity and overflow amount of the slurry, and establish the correlation relationship between the cleaning cavity series and the slurries, thereby providing the reference basis for changing types of the cavity series for different incoming materials and operating conditions.

In order to handle the temporary suspension of coating and long time suspension of coating, the work conditions of the slurry overfilling the cleaning cavity one time or the work conditions of the slurry overflowing into the cleaning cavity over time are subdivided, and the automatic dynamic cleaning manner and the periodic cleaning manner are used to prevent the cleaning cavity from being overfilled with the slurry.

In order to overcome deficiencies in the existing art, the present disclosure provides a cleaning cavity series for extrusion type coating and a cleaning method for extrusion type coating to solve the technical defects such as the inability to achieve the penetration of cleaning, the failure of the cleaning function and the like caused by the mismatch of the cleaning cavity with the slurry viscosity in the existing art.

To solve the preceding technical problems, the present disclosure adopts the technical solutions described below.

A cleaning cavity series for extrusion type coating is provided. The cleaning cavity series for extrusion type coating includes a plurality of cleaning cavities, where the plurality of cleaning cavities form the cleaning cavity series, each of the plurality of cleaning cavities is provided with an inner cavity body, a cleaning cavity opening portion in communication with the inner cavity body is disposed on a side portion of each of the plurality of cleaning cavities, and cross-section outlines of the inner cavity bodies of the plurality of cleaning cavities are a series of curves with an equal chord length.

As an improvement of the preceding technical solution, the cross-section outlines of the inner cavity bodies of the plurality of cleaning cavities of the cleaning cavity series are a series of arcs with an equal chord length.

As an improvement of the preceding technical solution, the cleaning cavity series includes five cleaning cavities, five inner cavity bodies corresponding to the five cleaning cavities are a first inner cavity body, a second inner cavity body, a third inner cavity body, a fourth inner cavity body and a fifth inner cavity body, and cross-section diameters of the first inner cavity body, the second inner cavity body, the third inner cavity body, the fourth inner cavity body and the fifth inner cavity body are 3.2 mm, 3.5 mm, 4 mm, 5 mm and 6 mm, respectively.

As an improvement of the preceding technical solution, sealing strip mounting grooves are disposed on an upper inner sidewall and a lower inner sidewall of the cleaning cavity opening portion of each of the plurality of cleaning cavities, a sealing strip is mounted in each of the sealing strip mounting grooves, cleaning cavity opening portions respectively corresponding to the plurality of cleaning cavities in the cleaning cavity series have a same size, and the sealing strip mounting grooves respectively corresponding to the plurality of cleaning cavities in the cleaning cavity series have the same size, the sealing strip is suitable for each of the plurality of cleaning cavities in the cleaning cavity series, and universal end-face sealing plates adapted to each of the plurality of cleaning cavities in the cleaning cavity series are respectively disposed at both ends of the plurality of cleaning cavities.

A cleaning method for extrusion type coating is provided. The cleaning method includes steps S1 and S2 described below.

In S1, an envelope line of a slurry that overflows from a lip portion of a coating head is evaluated, one cleaning cavity is selected from a cleaning cavity series to ensure that an enveloped area of the envelope line accounts for 30%-70% of the sectional area of an inner cavity body of the selected cleaning cavity, where a space outside an envelope of the envelope line in the inner cavity body is a fast penetration passage for a cleaning agent when the cleaning cavity performs a cleaning operation.

The space outside the envelope of the envelope line refers to a space outside the enveloped range of the envelope line in the selected cleaning cavity.

In S2, a static cleaning method or a dynamic cleaning method is selected according to a planned downtime to perform the cleaning operation on the coating head using the selected cleaning cavity from the cleaning cavity series.

As an improvement of the preceding technical solution, the envelope line of the slurry that overflows from the lip portion of the coating head is positively correlated with an overflow amount of the slurry, and the overflow amount of the slurry is affected by more of the following factors: a viscosity of the slurry, a pump speed of a coating machine, a closing speed of a valve of the coating head, a thickness of a gasket of the coating head and a gravity overflow; where the overflow amount of the slurry is mainly related to the viscosity of the slurry when sizes and parameters of relevant mechanisms are relatively determined.

As an improvement of the preceding technical solution, a method for selecting the cleaning cavity according to the viscosity of the slurry is: dividing the viscosity of the slurry into a plurality of grades according to the number of cleaning cavities in the cleaning cavity series, matching a viscosity of each grade with one cleaning cavity in the cleaning cavity series, selecting a cleaning cavity with a small inner cavity body from the cleaning cavity series for a slurry with a low viscosity, where a cleaning cavity with an increased inner cavity body is selected from the cleaning cavity series as the viscosity grade increases.

As an improvement of the preceding technical solution, the viscosity of the slurry is divided into five grades: 2000 cp, 4000 cp, 8000 cp, 12000 cp and 20000 cp, the cleaning cavity series includes five cleaning cavities, five inner cavity bodies corresponding to the five cleaning cavities are a first inner cavity body, a second inner cavity body, a third inner cavity body, a fourth inner cavity body and a fifth inner cavity body, cross-sections of the first inner cavity body, the second inner cavity body, the third inner cavity body, the fourth inner cavity body and the fifth inner cavity body are five arcs with an equal chord length, and diameters of the five arcs with the equal chord length are 3.2 mm, 3.5 mm, 4 mm, 5 mm and 6 mm, respectively.

As an improvement of the preceding technical solution, the static cleaning method is a one-time cleaning method, and the static cleaning method is a cleaning method adopted by a coating device during coating, in a coating interval or when the coating device is temporarily shut down; in the static cleaning method, the cleaning agent is introduced into a remaining flow passage outside an enveloped range of the the envelope line in the inner cavity body, and the flowing cleaning agent rapidly penetrates the inner cavity body of the cleaning cavity and carries a residual overflowed slurry so that the residual overflowed slurry flows out from one end of the inner cavity body of the cleaning cavity.

As an improvement of the preceding technical solution, the dynamic cleaning method is a periodic cleaning method, the dynamic cleaning method is used when the coating device is shut down for a long time or when a volume of the inner cavity body filled with the slurry accounts for great than 70% of a volume of the inner cavity body of the cleaning cavity due to a long downtime, and the dynamic cleaning method includes a complete operation cycle of cleaning agent cleaning, moisturizing, and air purging to remove the residual cleaning agent. A reference cleaning period of the dynamic cleaning method when the coating device is shut down for a long time is 30-60 min. In an exemplary embodiment of the present disclosure, the number of times of dynamic cleaning is not limited thereto, and the downtime is not limited thereto and may last for several days.

The present disclosure has the following beneficial effects: the present disclosure provides a cleaning cavity series for extrusion type coating and a cleaning method for extrusion type coating, the cleaning cavity series for extrusion type coating and the cleaning method for extrusion type coating provide a cleaning cavity series, and a suitable cleaning cavity is selected from the cleaning cavity series for cleaning so that the coating head has a very high cleaning success rate during cleaning, thereby greatly improving the cleaning efficiency and coating efficiency, achieving a higher degree of automation, reducing the labor intensity and labor cost, and helping to improve the production efficiency of the enterprises.

In conclusion, the cavity series for pressing, coating and cleaning and the cleaning method for extrusion type coating solve the technical defects such as the inability to achieve the penetration of cleaning, the failure of the cleaning function and the like caused by the mismatch of the cleaning cavity with the slurry viscosity in the existing art.

### BRIEF DESCRIPTION OF DRAWINGS

The present disclosure is further described below in conjunction with drawings and embodiments.

FIG. 1 is a principle view of the structure of a cleaning cavity series for extrusion type coating according to an embodiment one of the present disclosure;

FIG. 2 is a principle view of the sealing of a cleaning cavity series for extrusion type coating according to an embodiment one of the present disclosure; and

FIG. 3 is a flowchart of a cleaning method for pressing, coating and cleaning of the present disclosure.

### DETAILED DESCRIPTION

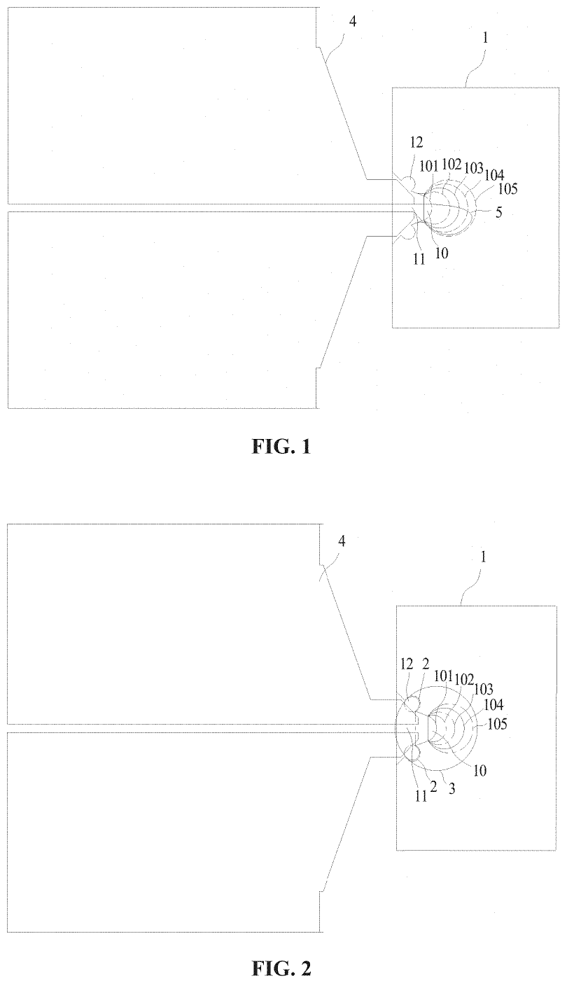

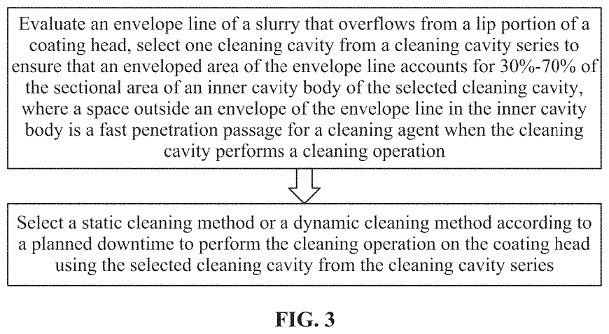

To provide a fuller understanding of objects, features and advantages of the present disclosure, a clear and complete description of the concept, specific structures and produced technical effects of the present disclosure will be given below in conjunction with the drawings and embodiments. Apparently, the embodiments described below are part, not all, of the embodiments of the present disclosure. Based on the embodiments of the present disclosure, all other embodiments obtained by those skilled in the art without creative work are within the scope of the present disclosure. In addition, all coupling/connection relationships involved in the patent do not just refer to the direct connection of components, but to the better coupling structures formed by adding or reducing coupling accessories according to the specific implementation. If not in collision, various technical features in the present disclosure can be combined interactively, as shown in FIGS. 1 to 3.

A cleaning cavity series for extrusion type coating is provided. The cleaning cavity series for extrusion type coating includes multiple cleaning cavities 1, where the multiple cleaning cavities 1 form the cleaning cavity series, each cleaning cavity 1 is provided with an inner cavity body 10, a cleaning cavity opening portion 11 in communication with the inner cavity body 10 is disposed on a side portion of each cleaning cavity 1, and cross-section outlines of the inner cavity bodies 10 of the multiple cleaning cavities 1 are a series of curves with an equal chord length.

In an exemplary embodiment, the cross-section outlines of the inner cavity bodies 10 of the multiple cleaning cavities 1 of the cleaning cavity series are a series of arcs with an equal chord length.

In an embodiment of the present disclosure, the cleaning cavity series includes five cleaning cavities 1, five inner cavity bodies 10 corresponding to the five cleaning cavities 1 are a first inner cavity body 101, a second inner cavity body 102, a third inner cavity body 103, a fourth inner cavity body 104 and a fifth inner cavity body 105, cross-section diameters of the first inner cavity body 101, the second inner cavity body 102, the third inner cavity body 103, the fourth inner cavity body 104 and the fifth inner cavity body 105 are 3.2 mm, 3.5 mm, 4 mm, 5 mm and 6 mm, respectively, and the sizes of the connections where the cleaning cavity opening portion 11 is connected to the first inner cavity body 101, the second inner cavity body 102, the third inner cavity body 103, the fourth inner cavity body 104 and the fifth inner cavity body 105 respectively are the same.

In other embodiments, 2, 3, 4, 6, 7, 8, 9 or 10 may be selected as the number of cleaning cavities 1 included in the cleaning cavity series, and any suitable number may be selected according to the specific implementation environments to form a suitable number of grades.

In an exemplary embodiment, other curves with an equal chord length may be selected as the cross-sectional outlines of the inner cavity bodies 10 of the cleaning cavity series, such as ellipses.

All inventions based on the serialization concept are within the scope of the present disclosure.

Before the cleaning function of the cleaning cavity 1 is enabled, the sealing between the cleaning cavity 1 and the coating head 4 should be ensured. Otherwise, the slurry overflows due to the poor sealing, deteriorating the working environment of the coating head 4.

Therefore, in the present technical solution, sealing strip mounting grooves 12 are disposed on an upper inner sidewall and a lower inner sidewall of the cleaning cavity opening portion 11 of each cleaning cavity 1, a sealing strip 12 is mounted in each sealing strip mounting groove 12, the cleaning cavity opening portions 11 respectively corresponding to the cleaning cavities 1 in the cleaning cavity series have a same size, and the sealing strip mounting grooves 12 respectively corresponding to the plurality of cleaning cavities 1 in the cleaning cavity series have the same size, the sealing strip 2 is suitable for each cleaning cavity 1 in the cleaning cavity series, and universal end-face sealing plates 3 adapted to each cleaning cavity 1 in the cleaning cavity series are respectively disposed at both ends of the multiple cleaning cavities 1.

In an exemplary embodiment, after the sealing strip 2 is fixed in the sealing strip mounting groove 12, the outwardly extending portion of the sealing strip 2 and the upper sidewall and lower sidewall of the lip portion of the coating head 4 form a line seal, and the end-face sealing plate 3 and the end face of the multiple cleaning cavities 1 form a face seal. In each cleaning cavity 1 in the cleaning cavity series, except that sizes of the inner cavity bodies 10 are different, other sizes are the same, and other components are universal. In this manner, when the cleaning cavities are changed for slurries of different viscosities, the end-face sealing mechanism does not need to be replaced, thereby reducing the material for type replacement and the time for type replacement, reducing the time cost, and improving the efficiency.

For material selection, the hardness and compression degree of the sealing strip 2 need to ensure the following sealing effect: in the case of operation errors, even at the maximum pressure of the factory, good sealing can still be achieved, and the cleaning agent or the slurry cannot be leaked.

Based on the preceding cleaning cavity series for extrusion type coating, the present disclosure further provides a cleaning method for extrusion type coating. The cleaning method includes steps S1 and S2 described below.

In S1, an envelope line 5 of a slurry that overflows from a lip portion of a coating head 4 is evaluated, one cleaning cavity 1 is selected from a cleaning cavity series to ensure that an enveloped area of the envelope line 5 accounts for 30%-70% of the sectional area of an inner cavity body 10 of the selected cleaning cavity 1, where a space outside an envelope of the envelope line 5 in the inner cavity body 10 is a fast penetration passage for a cleaning agent when the cleaning cavity 1 performs a cleaning operation.

In S2, a static cleaning method or a dynamic cleaning method is selected according to a planned downtime to perform the cleaning operation on the coating head 4 using the selected cleaning cavity 1 from the cleaning cavity series.

The preceding 30%-70% is a range value with a higher cleaning success rate and a better cleaning effect obtained by the inventors in the actual test process. In practical application, preferably, the enveloped area of the envelope line 5 is half of the sectional area of the inner cavity body 10.

In an exemplary embodiment, the envelope line 5 of the slurry that overflows from the lip portion of the coating head 4 is positively correlated with the overflow amount of the slurry, and the overflow amount of the slurry is affected by more of the following factors: a viscosity of the slurry, a pump speed of a coating machine, a closing speed of a valve of the coating head, a thickness of a gasket of the coating head and a gravity overflow; where the overflow amount of the slurry is mainly related to the viscosity of the slurry when sizes and parameters of relevant mechanisms are relatively determined.

In the preceding factors, factors including the pump speed of the coating machine, the closing speed of the valve of the coating head, the thickness of the gasket of the coating head and the gravity overflow are relatively controllable or less variable, and once the equipment commissioning is completed, these factors may not be easily changed. Therefore, the main factor affecting the overflow amount of the slurry is the viscosity of the slurry, because the viscosity of the slurry is changed at any time according to the coating of the coated product and needs to be changed frequently.

As can be seen, the viscosity of the slurry is the main factor affecting the envelope line 5 of the slurry overflow at the lip portion of the coating head 4 after the equipment commissioning is completed. Therefore, it is significantly necessary to establish the relationship between the viscosity of the slurry and a certain cleaning cavity in the cleaning cavity series.

In an exemplary embodiment, a method for selecting the cleaning cavity 1 according to the viscosity of the slurry is: the viscosity of the slurry is divided into multiple grades according to the number of cleaning cavities 1 in the cleaning cavity series, a viscosity of each grade is matched with one cleaning cavity 1 in the cleaning cavity series, a cleaning cavity 1 with a small inner cavity body 10 is selected from the cleaning cavity series for a slurry with a low viscosity, where a cleaning cavity with an increased inner cavity body 10 is selected from the cleaning cavity series as the viscosity grade increases.

In the present disclosure, preferably, the viscosity of the slurry is divided into five grades: 2000 cp, 4000 cp, 8000 cp, 12000 cp and 20000 cp, the cleaning cavity series includes five cleaning cavities 1, five inner cavity bodies 10 corresponding to the five cleaning cavities 1 are a first inner cavity body 101, a second inner cavity body 102, a third inner cavity body 103, a fourth inner cavity body 104 and a fifth inner cavity body 105, cross-sections of the first inner cavity body 101, the second inner cavity body 102, the third inner cavity body 103, the fourth inner cavity body 104 and the fifth inner cavity body 105 are five arcs with an equal chord length, and diameters of the five arcs with the equal chord length are 3.2 mm, 3.5 mm, 4 mm, 5 mm and 6 mm, respectively.

In the preceding technical solution, the viscosity of the slurry is divided into five grades, and the cleaning cavity series includes five cleaning cavities 1, each of which corresponds to a respective one of the five grades into which the viscosity of the slurry is divided.

In the preceding technical solution, when the cleaning cavity 1 is selected in practical application, if the cleaning cavity 1 with the first inner cavity body 101 is selected for the slurry with a viscosity of 4000 cp, the probability where the overflow amount of the slurry exceeds 70% of the sectional area of the cavity is high, that is, the penetration rate of the cleaning agent is reduced (clogging of the slurry), causing the failure of the cleaning function.

In the preceding technical solution, if the cleaning cavity 1 with the third inner cavity body 103 is selected for the slurry with the viscosity of 4000 cp, the slurry in the coating head 4 is heavily diluted, a long uneven coating is produced on a coated foil, and the generated waste is long, which is not conducive to the improvement of economic benefits.

In the technical solution provided by the present disclosure, the cleaning cavity series with different grades can be applied not only to deal with the case of various viscosities of a single slurry, but also to deal with the case of the mixed use of various slurries, and such a cleaning cavity series has the advantages of having a strong universality and being convenient and flexible to apply.

In an exemplary embodiment, the static cleaning method is a one-time cleaning method, and the static cleaning method is a cleaning method adopted by a coating device during coating, in a coating interval or when the coating device is temporarily shut down; in the static cleaning method, the cleaning agent is introduced into a remaining flow passage outside an enveloped range of the envelope line 5 in the inner cavity body 10, and the flowing cleaning agent rapidly penetrates the inner cavity body 10 of the cleaning cavity 1 and carries a residual overflowed slurry so that the residual overflowed slurry flows out from one end of the inner cavity body 10 of the cleaning cavity 1.

The static cleaning method adopts a principle of spatial separation. The envelope line 5 of the slurry that overflows from the lip portion of the coating head 4 is evaluated, the envelope area of the envelope line 5 should account for 30%-70% of the area of one curve selected from a series of curves with an equal chord length, and the remaining volume is used for the cleaning agent to quickly pass through.

In an exemplary embodiment, the dynamic cleaning method is a periodic cleaning method, the dynamic cleaning method is used when the coating device is shut down for a long time or when a volume of the inner cavity body 10 filled with the slurry accounts for more than 70% of the volume of the inner cavity body 10 of the cleaning cavity due to a long downtime, and the dynamic cleaning method includes at least one of cleaning agent cleaning or air purging cleaning to timely and periodically perform cleaning. In this manner, the slurry is prevented from filling the inner cavity body 10 of the whole cleaning cavity 1 and becoming dried, and the problems that the cleaning cavity 1 cannot be penetrated and the cleaning function fails are avoided, thereby ensuring that the cleaning cavity 1 can be used normally and that the coating device is in a normal coating state at all times. The cleaning period of the dynamic cleaning method when the coating device is shut down is 30-60 min, and the number of cleaning times per day is 2-24 when the coating device is shut down. The preceding is only a preferred dynamic cleaning method of the present disclosure. In other embodiments, the number of cleaning times is not limited thereto, the downtime is not limited thereto and may even last for several days, and different cleaning times and interval periods may be set according to specific implementation conditions and environments.

The dynamic cleaning method adopts a principle of time separation. The overflow amount of the slurry may exceed half the volume of the inner cavity body 10 of the entire cleaning cavity 1 or even the slurry may fill the whole inner cavity body 10 of the entire cleaning cavity 1. Alternatively, when the coating device is shut down for a long time, the cleaning cavity 1 is cleaned timely and periodically to prevent the slurry from filling the entire inner cavity body 10 and becoming dried, and to avoid the problem that the inner cavity body 10 cannot be penetrated. The dynamic cleaning method can avoid the failure of the cleaning function.

Before the preceding technical solution is adopted, the coating slurry is dried within about 10 seconds, resulting in the missing coating.

After the technical solution provided by the present disclosure is adopted, the slurry at the lip portion of the coating head 1 can be kept from being dried for 24 hours or even a longer time, which is very important for the normal operation of enterprises.

The preceding is the specific description of preferred embodiments of the present disclosure. However, the present disclosure is not limited to the preceding embodiments. Various equivalent modifications or substitutions may be made by those skilled in the art without departing from the spirit of the present disclosure. These equivalent modifications or substitutions fall within the scope of the claims in the present application.

What is claimed is:

1. A cleaning cavity series for extrusion type coating, comprising a plurality of cleaning cavities (1), wherein the plurality of cleaning cavities (1) form the cleaning cavity series, each of the plurality of cleaning cavities (1) is provided with an inner cavity body (10), a cleaning cavity opening portion (11) in communication with the inner cavity body (10) is disposed on a side portion of each of the plurality of cleaning cavities (1), and cross-section outlines of inner cavity bodies (10) of the plurality of cleaning cavities (1) are a series of curves with an equal chord length.

2. The cleaning cavity series for extrusion type coating according to claim 1, wherein the cross-section outlines of the inner cavity bodies (10) of the plurality of cleaning cavities (1) of the cleaning cavity series are a series of arcs with an equal chord length.

3. The cleaning cavity series for extrusion type coating according to claim 2, wherein the cleaning cavity series comprises five cleaning cavities (1), five inner cavity bodies (10) corresponding to the five cleaning cavities (1) are a first inner cavity body (101), a second inner cavity body (102), a third inner cavity body (103), a fourth inner cavity body (104) and a fifth inner cavity body (105), and cross-section diameters of the first inner cavity body (101), the second inner cavity body (102), the third inner cavity body (103), the fourth inner cavity body (104) and the fifth inner cavity body (105) are 3.2 mm, 3.5 mm, 4 mm, 5 mm and 6 mm, respectively.

4. The cleaning cavity series for extrusion type coating according to claim 1, wherein sealing strip mounting grooves (12) are disposed on an upper inner sidewall and a lower inner sidewall of the cleaning cavity opening portion (11) of each of the plurality of cleaning cavities (1), a sealing strip (2) is mounted in each of the sealing strip mounting grooves (12), cleaning cavity opening portions (11) respectively corresponding to the plurality of cleaning cavities (1) in the cleaning cavity series have a same size, and the sealing strip mounting grooves (12) respectively corresponding to the plurality of cleaning cavities (1) in the cleaning cavity series have a same size, the sealing strip (2) is suitable for each of the plurality of cleaning cavities (1) in the cleaning cavity series, and a universal end-face sealing plates (3) adapted to each of the plurality of cleaning cavities (1) in the cleaning cavity series are respectively disposed at both ends of the plurality of cleaning cavities (1).

5. A cleaning method for extrusion type coating, comprising the following steps:
S1: evaluating an envelope line (5) of a slurry that overflows from a lip portion of a coating head (4), selecting one cleaning cavity (1) from a cleaning cavity series to ensure that an enveloped area of the envelope line (5) accounts for 30%-70% of a sectional area of an inner cavity body (10) of the selected cleaning cavity (1), wherein a space outside an envelope of the envelope line (5) in the inner cavity body (10) is a fast penetration passage for a cleaning agent when the cleaning cavity (1) performs a cleaning operation; and
S2: selecting a static cleaning method or a dynamic cleaning method according to a planned downtime to perform the cleaning operation on the coating head (4) using the selected cleaning cavity (1) from the cleaning cavity series.

6. The cleaning method for extrusion type coating according to claim 5, wherein the envelope line (5) of the slurry that overflows from the lip portion of the coating head (4) is positively correlated with an overflow amount of the slurry, and the overflow amount of the slurry is affected by more of the following factors: a viscosity of the slurry, a pump speed of a coating machine, a closing speed of a valve of the coating head, a thickness of a gasket of the coating head and a gravity overflow; wherein the overflow amount of the slurry is mainly related to the viscosity of the slurry when sizes and parameters of relevant mechanisms are determined.

7. The cleaning method for extrusion type coating according to claim 6, wherein a method for selecting the cleaning cavity (1) according to the viscosity of the slurry is: dividing the viscosity of the slurry into a plurality of grades according to a number of cleaning cavities (1) in the cleaning cavity series, matching a viscosity of each grade with one cleaning cavity (1) in the cleaning cavity series, selecting a cleaning cavity (1) with a small inner cavity body (10) from the cleaning cavity series for a slurry with a low viscosity, wherein a cleaning cavity (1) with an increased inner cavity body (10) is selected from the cleaning cavity series as the viscosity grade increases.

8. The cleaning method for extrusion type coating according to claim 7, wherein the viscosity of the slurry is divided into five grades: 2000 cp, 4000 cp, 8000 cp, 12000 cp and 20000 cp, the cleaning cavity series comprises five cleaning cavities (1), five inner cavity bodies (10) corresponding to the five cleaning cavities (1) are a first inner cavity body (101), a second inner cavity body (102), a third inner cavity body (103), a fourth inner cavity body (104) and a fifth inner cavity body (105), cross-sections of the first inner cavity body (101), the second inner cavity body (102), the third inner cavity body (103), the fourth inner cavity body (104) and the fifth inner cavity body (105) are five arcs with an equal chord length, and diameters of the five arcs with the equal chord length are 3.2 mm, 3.5 mm, 4 mm, 5 mm and 6 mm, respectively.

9. The cleaning method for extrusion type coating according to claim 5, wherein the static cleaning method is a one-time cleaning method, and the static cleaning method is a cleaning method adopted by a coating device during coating, in a coating gap or when the coating device is temporarily stopped; in the static cleaning method, the cleaning agent is introduced into a remaining flow passage outside an enveloped range of the the envelope line (5) in the inner cavity body (10), and the flowing cleaning agent rapidly penetrates the inner cavity body (10) of the cleaning cavity (1) and carries a residual overflowed slurry so that the residual overflowed slurry flows out from one end of the inner cavity body (10) of the cleaning cavity (1).

10. The cleaning method for extrusion type coating according to claim 5, wherein the dynamic cleaning method is a periodic cleaning method, the dynamic cleaning method is used when the coating device is shut down for a long time or when a volume of the inner cavity body (10) filled with the slurry accounts for greater than 70% of a volume of the inner cavity body (10) of the cleaning cavity (1) due to a long downtime, the dynamic cleaning method comprises at least one of cleaning agent cleaning or air purging cleaning, and a reference cleaning period of the dynamic cleaning method when the coating device is shut down for a long time is 30-60 min.
